(19) United States
(12) Patent Application Publication
(10) Pub. No.: US 2023/0368416 A1
(43) Pub. Date: Nov. 16, 2023

(54) POSE DETECTION DEVICE, POSE DETECTION SYSTEM, AND POSE DETECTION METHOD

(71) Applicant: NEC Corporation, Tokyo (JP)

(72) Inventor: Masahito Sakai, Tokyo (JP)

(73) Assignee: NEC Corporation, Tokyo (JP)

(21) Appl. No.: 18/141,191

(22) Filed: Apr. 28, 2023

(30) Foreign Application Priority Data
May 11, 2022 (JP) 2022-077929

(51) Int. Cl. G06T 7/73

(52) U.S. Cl. CPC G06T 7/73

(57) ABSTRACT

A frame of interest to be subjected to pose detection is acquired from a plurality of time series frames, a joint point of a subject reflected in the frame of interest is detected. It is determined that a joint point to be detected in the frame of interest cannot be detected when the detected joint point is not the joint point to be detected. A joint point associated to the joint point to be detected with respect to each of a plurality of frames other than the frame of interest is searched for among the plurality of time-series frames when the joint point to be detected cannot be detected. The joint point to be detected is interpolated according to a search result.

### INCORPORATION BY REFERENCE

This application is based upon and claims the benefit of priority from Japanese patent application No. 2022-77929, filed on May 11, 2022, the disclosure of which is incorporated herein in its entirety by reference.

### TECHNICAL FIELD

The present disclosure relates to a pose detection device, a pose detection system, and a pose detection method.

### BACKGROUND ART

In recent years, techniques (Japanese Unexamined Patent Application Publication No. 2005-107247, Japanese Unexamined Patent Application Publication No. 2018-32155, Japanese Unexamined Patent Application Publication No. 2020-198019, Japanese Unexamined Patent Application Publication No. 2021-105850, and Japanese Unexamined Patent Application Publication No. 2021-135877) for detecting an object or the like from an image or a moving image captured by a camera have been widely used. Among the techniques, use of methods (Japanese Unexamined Patent Application Publication No. 2020-198019 and Japanese Unexamined Patent Application Publication No. 2021-135877) of detecting a person who is reflected in an image or a moving image and automatically detecting a pose of the detected person has been developed.

For example, a method (Japanese Unexamined Patent Application Publication No. 2005-107247) of correcting a position and orientation measurement value by using a correction value acquired at a past time in a case where detection or identification of an index fails in measuring the position and orientation by using the index has been proposed. In addition, for example, a method (Japanese Unexamined Patent Application Publication No. 2018-32155) of determining, when a position and orientation of an image capturing device are measured, a movement of the image capturing device, and preventing, when determining to be static, a blur of orientation information by using position and orientation information of a previous frame as it is has been proposed.

### SUMMARY

However, in the above-described method, when a pose of a subject is detected but there is a defect in the detected pose, for example, when detection of a part of joint points representing the pose of the subject fails, the pose cannot be corrected.

The present disclosure has been made in view of the above circumstance, and an example object of the present disclosure is to suitably correct a joint point even when detection of a part of the joint points representing a pose of a subject fails in detecting the pose of the subject.

In a first example aspect of the present disclosure a pose detection device includes: a memory configured to store instructions; and a processor configured to execute the instructions to: acquire a frame of interest to be subjected to pose detection from a plurality of time-series frames, and detect a joint point of a subject reflected in the frame of interest; determine that a joint point to be detected in the frame of interest cannot be detected when the detected joint point is not the joint point to be detected in the frame of interest; search for a joint point associated to a joint point to be detected in the frame of interest with respect to each of a plurality of frames other than the frame of interest among the plurality of time-series frames when a joint point to be detected in the frame of interest cannot be detected; interpolate a joint point to be detected in the frame of interest according to a search result.

In a second example aspect of the present disclosure, a pose detection system includes: an image capturing device configured to output an image acquired by capturing an area to be monitored; and a pose detection device configured to detect a pose of a subject being a person reflected in the image, in which the pose detection device includes a memory configured to store instructions; and a processor configured to execute the instructions to: acquire a frame of interest to be subjected to pose detection from a plurality of time-series frames, and detect a joint point of a subject reflected in the frame of interest, determine that a joint point to be detected in the frame of interest cannot be detected when the detected joint point is not the joint point to be detected in the frame of interest; search for a joint point associated to the joint point to be detected in the frame of interest with respect to each of a plurality of frames other than the frame of interest among the plurality of time-series frames when the joint point to be detected in the frame of interest cannot be detected; and interpolate the joint point to be detected in the frame of interest according to a search result.

In a third example aspect of the present disclosure, a pose detection system includes: an image capturing device configured to output an image acquired by capturing an area to be monitored; and a pose detection device configured to be incorporated in the image capturing device and detect a pose of a subject being a person reflected in the image, wherein the pose detection device includes a memory configured to store instructions; and a processor configured to execute the instructions to: acquire a frame of interest to be subjected to pose detection from a plurality of time-series frames, and detect a joint point of a subject reflected in the frame of interest, determine that a joint point to be detected in the frame of interest cannot be detected when the detected joint point is not a joint point to be detected in the frame of interest, search for a joint point associated to a joint point to be detected in the frame of interest with respect to each of a plurality of frames other than the frame of interest among the plurality of time-series frames when a joint point to be detected in the frame of interest cannot be detected, and interpolate a joint point to be detected in the frame of interest according to a search result.

In a fourth example aspect of the present disclosure, a pose detection method includes: acquiring a frame of interest to be subjected to pose detection from a plurality of time-series; detecting a joint point of a subject reflected in the frame of interest; determining that a joint point to be detected in the frame of interest cannot be detected when a detected joint point is not a joint point to be detected in the frame of interest; searching for a joint point associated to a joint point to be detected in the frame of interest with respect to each of a plurality of frames other than the frame of interest among the plurality of time-series frames when a joint point to be detected in the frame of interest cannot be detected; and interpolating a joint point to be detected in the frame of interest according to a search result of a joint point.

In a fifth example aspect of the present disclosure, a program causes a computer to execute: processing of acquiring a frame of interest to be subjected to pose detection from a plurality of time-series frames, and detecting a joint point of a subject reflected in the frame of interest; processing of determining that a joint point to be detected in the frame of interest cannot be detected when a detected joint point is not a joint point to be detected in the frame of interest; processing of searching for a joint point associated to a joint point to be detected in the frame of interest with respect to each of a plurality of frames other than the frame of interest among the plurality of time-series frames when a joint point to be detected in the frame of interest cannot be detected; and processing of interpolating a joint point to be detected in the frame of interest according to a search result of a joint point.

According to the present disclosure, a joint point can be suitably corrected even when detection of a part of the joint points representing a pose of a subject fails in detecting the pose of the subject.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a diagram schematically illustrating a configuration of a pose detection system according to a first example embodiment;

FIG. 2 is a diagram schematically illustrating a configuration of a pose detection device according to the first example embodiment;

FIG. 3 is a diagram schematically illustrating a modification example of a configuration of the pose detection device according to the first example embodiment;

FIG. 4 is a diagram schematically illustrating an arrangement of joint points detected by a joint point detection unit;

FIG. 5 is a flowchart of a pose detection operation of the pose detection system according to the first example embodiment;

FIG. 6 is a diagram illustrating a first example of a joint point between a frame of interest and a previous frame;

FIG. 7 is a diagram illustrating a second example of a joint point between a frame of interest and a previous frame;

FIG. 8 is a diagram illustrating a first example of a position of a joint point detected in a frame of interest and a position of an associated joint point (reference joint point) in a previous frame;

FIG. 9 is a diagram illustrating a second example of a position of a joint point detected in a frame of interest and a position of an associated joint point (reference joint point) in a previous frame;

FIG. 10 is a diagram illustrating an example of joint points in three consecutive frames;

FIG. 11 is a diagram illustrating an outline of performing interpolation of a joint point in Step S16;

FIG. 12 is a diagram illustrating an example of interpolating a joint point of a frame of interest by using three past frames;

FIG. 13 is a diagram illustrating an example in which a joint point being interpolated by interpolation processing is included in past frames;

FIG. 14 is a diagram illustrating an example of interpolating a joint point of a frame of interest by using three frames temporally later than a frame of interest;

FIG. 15 is a diagram illustrating an example of interpolating a joint point of a frame of interest by using both a past frame and a future frame;

FIG. 16 is a diagram schematically illustrating a configuration of a pose detection system according to a fourth example embodiment; and

FIG. 17 is a diagram illustrating a configuration example of a computer.

### EXAMPLE EMBODIMENT

Hereinafter, example embodiments of the present disclosure will be described with reference to the drawings. In the drawings, a similar element is denoted by a similar reference sign, and redundant description is omitted as necessary.

### First Example Embodiment

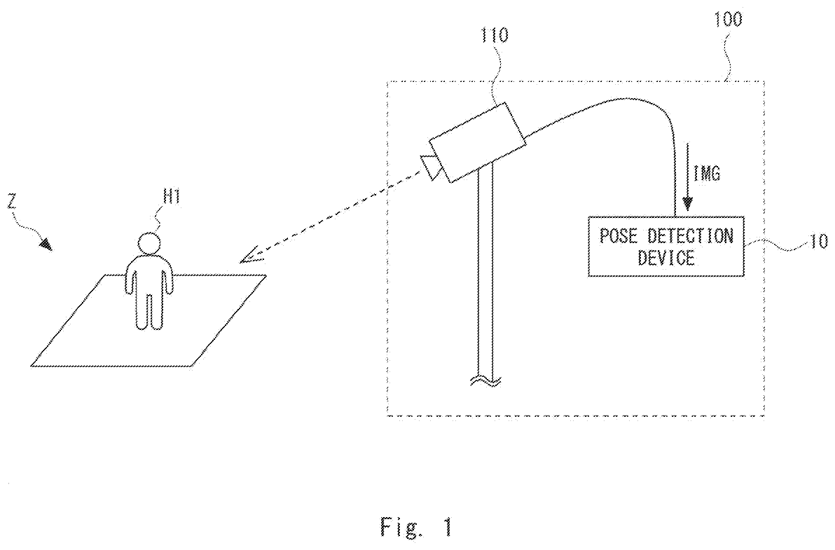

A pose detection system according to a first example embodiment will be described. FIG. 1 schematically illustrates a configuration of a pose detection system 100 according to the first example embodiment. The pose detection system 100 includes a camera 110 and a pose detection device 10. The camera 110 and the pose detection device 10 are communicably connected to each other by various communication means including wired or wireless communication. The camera 110 is configured as an image capturing device that continuously captures an image of a monitoring target area Z, for example, acquires as a moving image, and outputs the acquired image IMG to the pose detection device 10. The camera 110 may be capable of capturing in not limited to visible light but in a non-visible light region such as infrared light, and may be capable of projecting illumination light to the monitoring target area Z as appropriate. The pose detection device 10 detects a subject H1 being a person reflected in the acquired image IMG, performs image processing as necessary, and detects a pose of the detected subject H1.

The camera 110 acquires the image IMG of the monitoring target area Z in which the camera 110 is directed at an installation position of the camera 110, and outputs the acquired image IMG to the pose detection device 10.

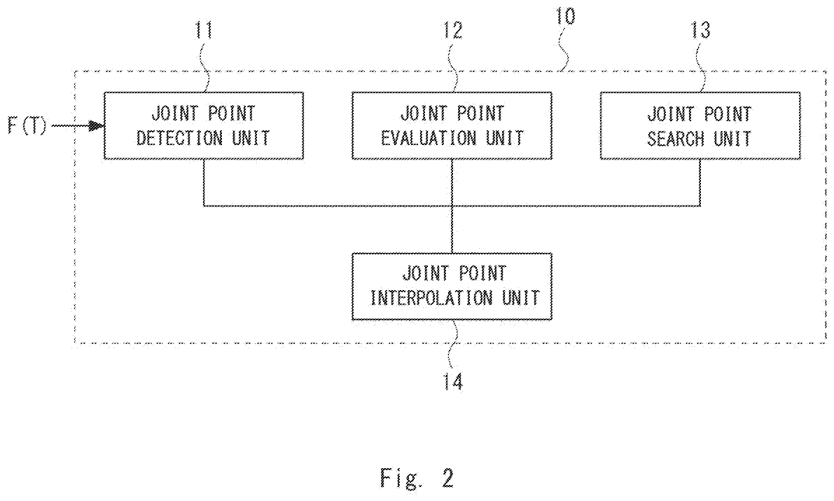

The pose detection device 10 will be described. FIG. 2 schematically illustrates a configuration of the pose detection device 10 according to the first example embodiment. The pose detection device 10 includes a joint point detection unit 11, a joint point evaluation unit 12, a joint point search unit 13, and a joint point interpolation unit 14.

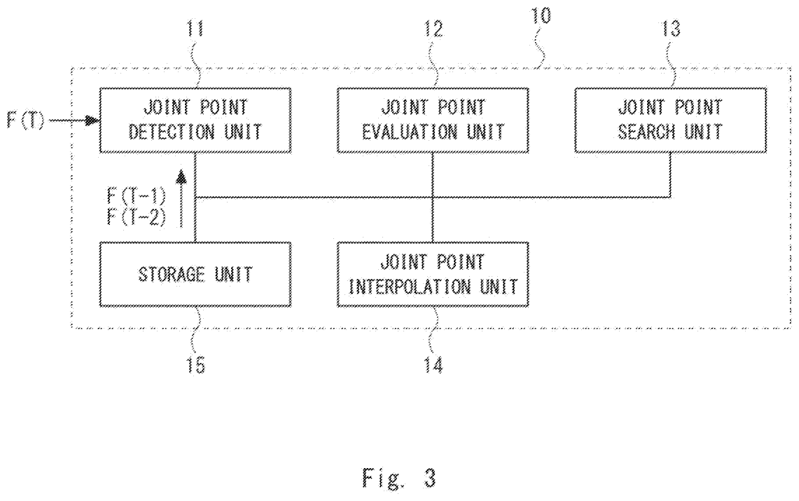

An image captured by the camera 110 may be stored and accumulated in the pose detection device 10 as appropriate. FIG. 3 schematically illustrates a modification example of a configuration of the pose detection device 10 according to the first example embodiment. In FIG. 3, a configuration is provided in which a storage unit 15 is added to the pose detection device 10 in FIG. 2. In the storage unit 15, the image IMG captured by the camera 110 may be continuously accumulated in the storage unit 15 in time series. Hereinafter, each of images acquired in time series (also referred to as time-series frames) is referred to as a frame. The joint point detection unit 11, the joint point evaluation unit 12, the joint point search unit 13, and the joint point interpolation unit 14 can appropriately read a frame used for processing from the storage unit 15.

Note that, a frame may be stored not only in the storage unit 15 but also in another storage unit provided outside the pose detection device 10. The joint point detection unit 11, the joint point evaluation unit 12, the joint point search unit 13, and the joint point interpolation unit 14 can appropriately read a frame used for processing from another storage unit.

The joint point detection unit 11 refers to a received frame, and detects a joint point of a subject reflected in the frame. Hereinafter, a frame to be subjected to joint point detection by the joint point detection unit 11 is referred to as a frame of interest. In the present example embodiment, it is assumed that a frame composed of the image IMG captured by the camera 110 is acquired as a frame of interest, and a joint point representing a pose of a subject is detected. Note that, the frame of interest is not limited to this, and the joint point detection unit 11 may appropriately use a frame acquired from the storage unit 15 as the frame of interest.

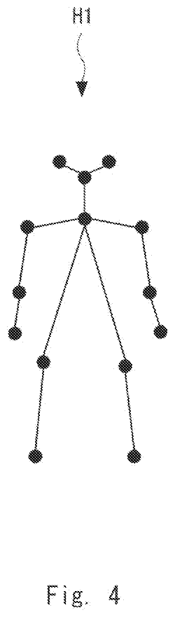

FIG. 4 schematically illustrates an arrangement of joint points detected by the joint point detection unit 11. Herein, it is assumed that 14 joint points are set in the subject H1 being in a state where standing toward a front side of a page space, and three points in a head, one point in a root of a neck, one point in a right shoulder, two points in a right arm, one point in a left shoulder, two points in a left arm, two points in a right foot, and two points in a left foot are arranged. In the present example embodiment, the joint point detection unit 11 is configured to detect the 14 joint points illustrated in FIG. 4 from an image of the subject H1 reflected in the acquired frame. In other words, the joint point detection unit 11 detects each of the set joint points (herein, 14 points). At this time, the joint point detection unit 11 may not be able to detect all of the joint points to be detected due to image quality of the acquired frame, a pose and movement of the subject H1, and the like. Therefore, the joint point detection unit 11 acquires, for each set joint point, a detection result indicating whether the joint point has been detected.

The joint point evaluation unit 12 compares a joint point detected in a frame of interest with a joint point in a temporally previous or succeeding (past or future) frame associated to the detected joint point, and determines whether positions of the two joint points are different from each other by a predetermined amount.

When there is a joint point in which the joint point detection unit 11 cannot detect in a frame of interest, the joint point search unit 13 searches for a joint point associated to a joint point that cannot be detected in a past or future frame.

The joint point interpolation unit 14 generates, by interpolation processing, a joint point that cannot be detected in a frame of interest according to processing results by the joint point evaluation unit 12 and the joint point search unit 13, and adds the generated joint point as a joint point of the frame of interest.

The storage unit 15 is configured to be able to store a plurality of frames, which are images captured by the camera 110 and have different capturing times with each other, in time series.

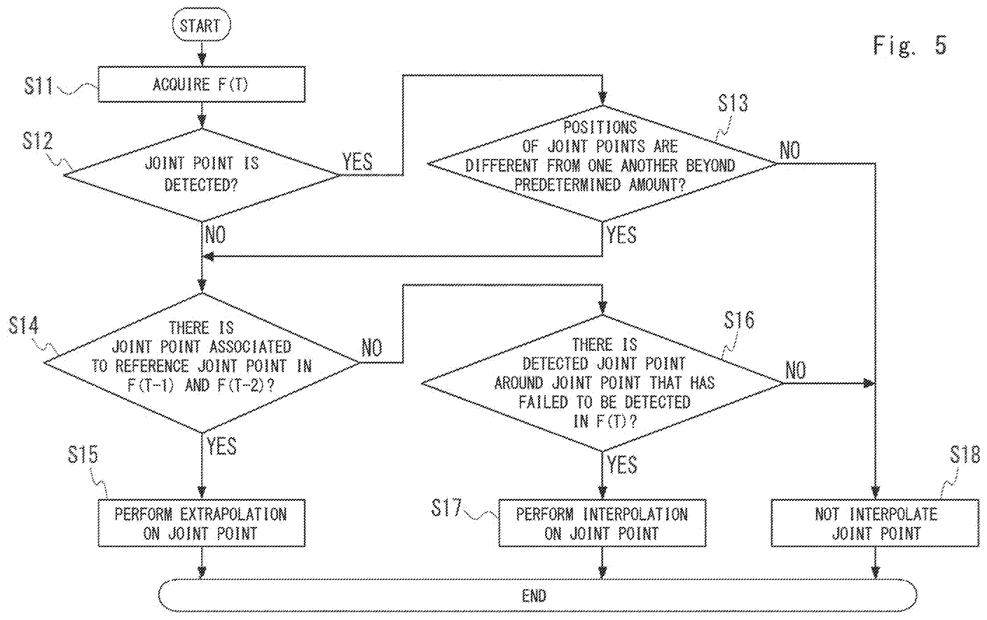

Next, a pose detection operation in the pose detection system 100 will be described. FIG. 5 is a flowchart of the pose detection operation of the pose detection system 100 according to the first example embodiment.

### Step S11

The joint point detection unit 11 acquires a frame of interest F(T). In the following description, a time at which a frame of interest is acquired is assumed to be T, and a past time more than T is assumed to be T−1 to T−N (where N is a positive integer of 2 or more) in temporally close order, and a future time more than T is assumed to be T+1 to T+M (where M is a positive integer of 2 or more) in temporally close order.

### Step S12

The joint point detection unit 11 performs processing of detecting a joint point of a subject reflected in the frame of interest F(T). Herein, for example, the joint point detection unit 11 determines whether a joint point to be detected can be detected with respect to the subject reflected in the frame of interest F(T). The joint point detection unit 11 proceeds the processing to Step S13 when the joint point of the subject is detected, and proceeds the processing to Step S14 when the joint point of the subject is not detected.

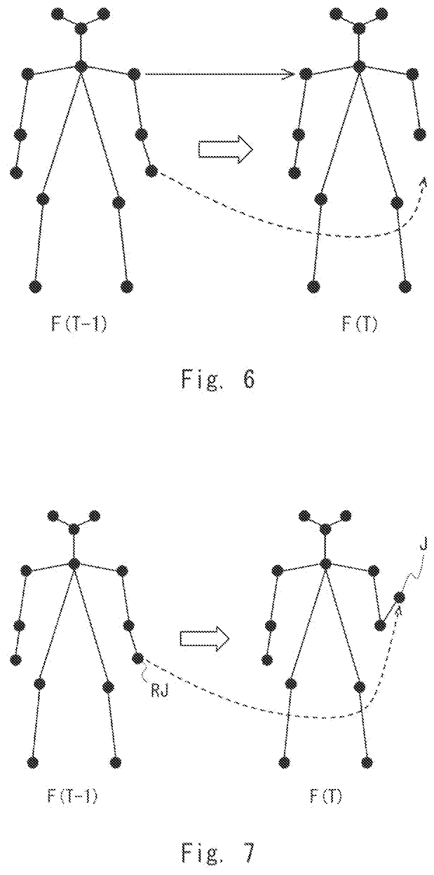

FIG. 6 illustrates a first example of joint points in the frame of interest F(T) and a previous frame F(T−1). In addition, although an operation described herein is performed for each joint point, the joint point at a left hand tip will be described as an example herein. In this example, while all 14 joint points exist in the previous frame F(T−1), detection of the joint point at the left hand tip fails in the frame of interest F(T). In this case, since the detection of the joint point to be present at the left hand tip has failed, the processing proceeds to Step S14.

FIG. 7 illustrates a second example of joint points in the frame of interest F(T) and the previous frame F(T−1). In this example, all 14 joint points are detected in also the frame of interest F(T). In this case, since the joint point to be present at the left hand tip has been detected, the processing proceeds to Step S13.

Note that, while the previous frame F(T−1) has been described herein as being referred to, a previous frame more than the frame F(T−1) may be referred to, as appropriate.

### Step S13

When the joint point detection unit 11 detects the joint point of the subject in Step S12 (FIG. 6), the joint point evaluation unit 12 compares a position of a joint point J detected in the frame of interest F(T) with a position of an associated joint point (reference joint point) RJ of the previous frame F(T−1), and determines whether the positions are different from each other beyond a predetermined amount.

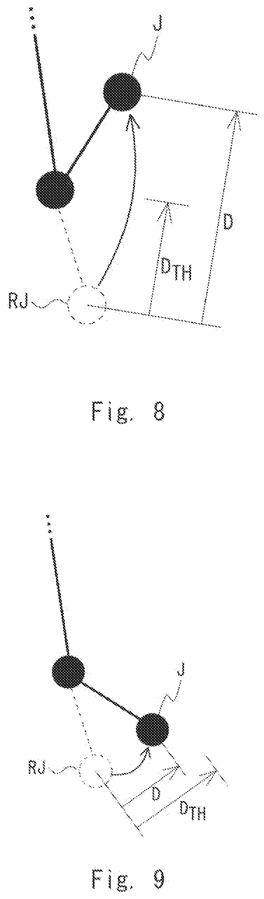

FIG. 8 illustrates a first example of the position of the joint point J detected in the frame of interest F(T) and the position of the associated joint point (reference joint point) RJ of the previous frame F(T−1). As illustrated in FIG. 8, when the position of the detected joint point J is farther than a predetermined distance DTH, that is, when a distance D between the position of the detected joint point J and the reference joint point RJ is longer than the predetermined distance DTH, the joint point J detected in the frame of interest F(T) is likely to be erroneously detected. In other words, when positions of two joint points to be estimated to represent the same joint in two frames that are temporally close to each other are compared, it is estimated that the positions of the two joint points are close to each other. Therefore, when the two joint points being compared are separated by a certain distance (a predetermined distance DTH) or more, it is conceivable that the newly detected joint point J of the frame of interest F(T) is likely to be erroneously detected. Therefore, the joint point evaluation unit 12 deletes, from the frame of interest F(T), the joint point J that may have been erroneously detected, and proceeds the processing to Step S14 assuming that a joint point has not been detected in the frame of interest F(T).

FIG. 9 illustrates a second example of the position of the joint point J detected in the frame of interest F(T) and the position of the associated joint point (reference joint point) RJ of the previous frame F(T−1). When the position of the joint point J is closer than the predetermined distance DTH, it is assumed that the joint point J associated to the joint point RJ of the previous frame F(T−1) can be detected on the frame of interest F(T), and the processing proceeds to Step S18.

### Step S14

When it is determined, in Steps S12 and S13, that the joint point J of the subject is not detected (S12: NO, S13: YES), the joint point search unit 13 determines whether a joint point associated to the joint point J that has failed to be detected exists over a plurality of previous frames. Herein, it is assumed that the previous frame F(T−1) and a previous frame F(T−2) being one previous to the previous frame F(T−1) are referred to as a plurality of previous frames. The frames to be referred to are not limited to this, and any two past frames may be referred to.

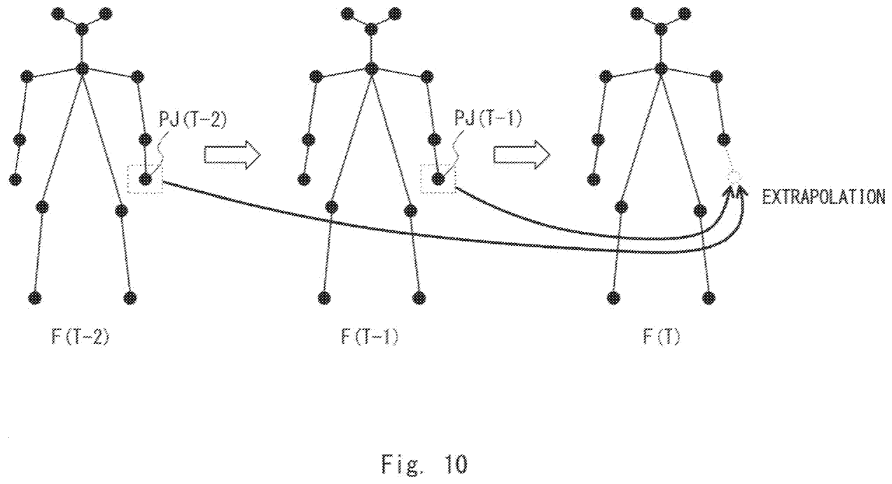

FIG. 10 illustrates an example of joint points in three consecutive frames. In this example, a joint point PJ(T−1) exists in the previous frame F(T−1) and a joint point PJ(T−2) exists in the previous frame F(T−2) being one previous to the previous frame F(T−1), as a joint point associated to a joint point of the left hand tip that could not be detected in the frame of interest F(T). Therefore, in a case in FIG. 10, since there is an associated joint point, the processing proceeds to Step S15.

On the other hand, when the associated joint point does not exist in any of the plurality of referred past frames, the processing proceeds to Step S16.

### Step S15

When the joint point associated to the joint point of the left hand tip that cannot be detected in the frame of interest F(T) exists in a plurality of past frames (S14: YES), the joint point interpolation unit 14 adds a joint point acquired by interpolating by using coordinates of the joint points in the plurality of past frames to the frame of interest F(T). Specifically, as illustrated in FIG. 10, coordinates acquired by performing extrapolation by using coordinates of the joint point PJ(T−1) of the previous frame F(T−1) and coordinates of the joint point PJ(T−2) of the previous frame F(T−2) being one previous to the previous frame F(T−1) are used as coordinates of the joint point J of the frame of interest F(T). The joint point interpolation unit 14 adds the joint point J acquired by performing extrapolation to the frame of interest F(T), and then ends the processing.

### Step S16

When the joint point associated to the joint point of the left hand tip that cannot be detected in the frame of interest F(T) does not exist in any of the plurality of past frames (S14: NO), the joint point interpolation unit 14 determines whether there is a detected joint point around a joint point that has failed to be detected among the detected joint points of the frame of interest F(T).

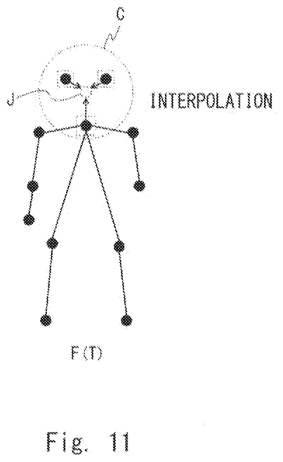

FIG. 11 illustrates an outline of performing interpolation of a joint point in Step S16. Herein, unlike the above description, it is assumed that a joint point of the frame of interest F(T) that could not be detected is a joint point in the center of the head. For example, the joint point interpolation unit 14 determines whether there is a detected joint point located inside a circle C having a predetermined radius.

### Step S17

When it is determined, in Step S16, that there is a detected joint point around a joint point that could not be detected (S16: YES), the joint point interpolation unit 14 adds a point of coordinates acquired by performing interpolation on the coordinates of the joint point around the detected joint point as the joint point of the frame of interest F(T). In the example in FIG. 11, the joint point interpolation unit 14 adds the joint point J acquired by performing interpolation by using coordinates of three joint points existing inside the circle C to the frame of interest F(T). Then, after adding the joint point J, the joint point interpolation unit 14 ends the processing.

### Step S18

When the positions of the joint points compared in Step S13 do not differ from each other beyond the predetermined amount (S13: NO), or when it is determined that there are no detected joint points around the joint points that could not be detected in Step S16 (S16: NO), the joint point interpolation unit 14 ends the processing without performing joint point interpolation processing.

By the above operation, even when detection of a joint point to be detected in the frame of interest F(T) fails, the joint point can be interpolated by the interpolation processing as appropriate.

In addition, even when a joint point to be detected is detected, it is determined whether the detected joint point is similar to a joint point detected in the previous and succeeding frames (Step S12), and the joint point can be replaced with a joint point interpolated by the interpolation processing according to a determination result.

In other words, it is determined whether the detected joint point is appropriate, and when not being appropriate, the detected joint point is replaced with the joint point acquired by the interpolation processing. Accordingly, it is possible to replace a joint point estimated to be erroneously detected with a more appropriate joint point, and it is possible to further improve detection accuracy of the joint point as compared with a general pose detection method.

### Second Example Embodiment

In the first example embodiment, a latest image IMG captured by a camera is used as a frame of interest, and interpolation processing is performed by using a previous frame and a previous frame being one previous to the previous frame, and thereby a joint point of the frame of interest is interpolated. However, a frame to be used is not limited thereto.

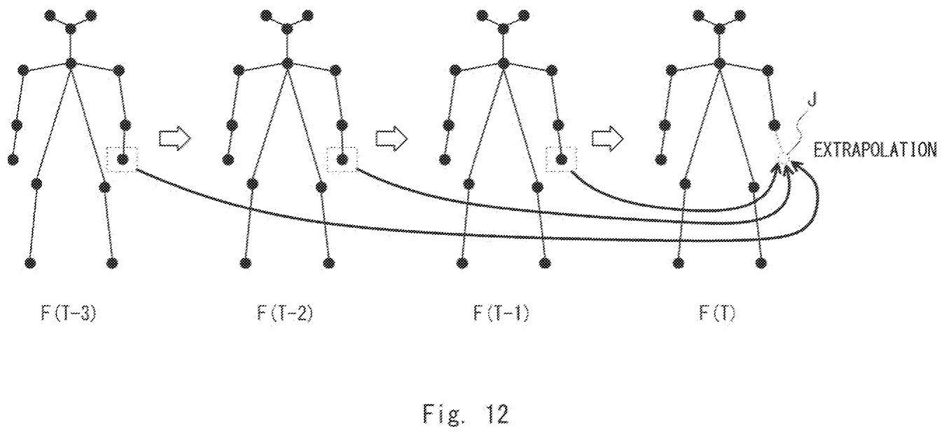

For example, three or more past frames may be used to interpolate a joint point of a frame of interest. Herein, for the sake of simplicity, an example in which a joint point of a frame of interest is interpolated by using three past frames will be described. FIG. 12 illustrates an example in which a joint point of a frame of interest are interpolated by using three past frames F(T−1) to F(T−3). In the three past frames F(T−1) to F(T−3), a joint point J of the frame of interest F(T) may be interpolated by detecting joint points associated to the joint point J and performing extrapolation on coordinates of the detected joint points. As described above, by performing the interpolation processing using three or more past frames, it is possible to interpolate the joint point J of the frame of interest F(T) with higher accuracy as compared with a case of performing the interpolation processing using two past frames as in the first example embodiment.

Note that, frames to be referred to are not limited to the frames F(T−1) to F(T−3), and may be a plurality of any past frames. In addition, as long as interpolation of a joint point can be appropriately performed, the plurality of past frames to be referred to may be continuous in time or may be intermittent.

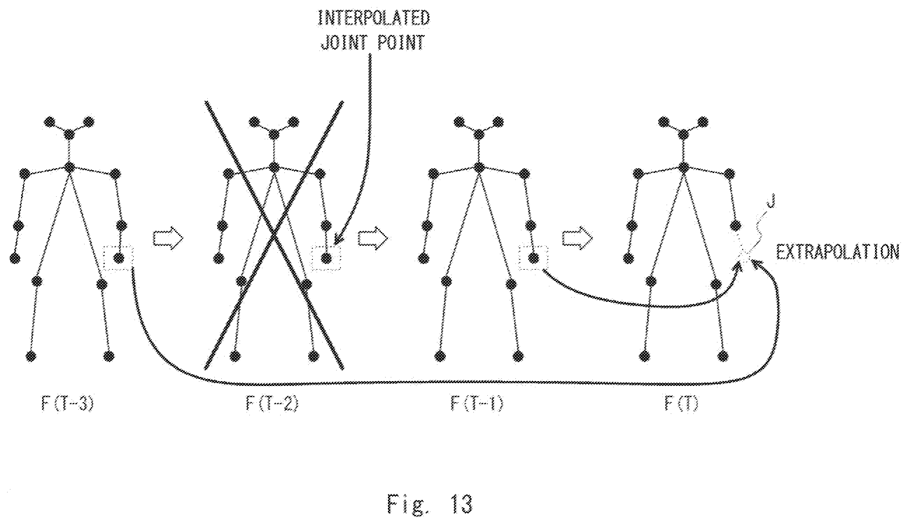

As described above, when the interpolation processing is performed by using three or more past frames, for example, a case in which a frame including a joint point interpolated by the interpolation processing in Step S14 or S16 described above is included is conceivable. FIG. 13 illustrates an example in which a joint point interpolated by the interpolation processing is included in a past frame. In this case, when the interpolation processing is performed by using coordinates of an interpolated joint point and the joint point of the frame of interest is further intended to be interpolated, there is a possibility that accuracy of a position of the interpolated joint point is lowered. Therefore, in this case, as illustrated in FIG. 13, the interpolation processing may be performed by using the previous frame F(T−1) and the frame F(T−3) being one previous of the previous frame F(T−2) being one previous to the previous frame, without using the previous frame F(T−2) including the interpolated joint point. As described above, by performing the interpolation processing by excluding the frame including the interpolated joint point, it is possible to accurately interpolate the joint point of the frame of interest.

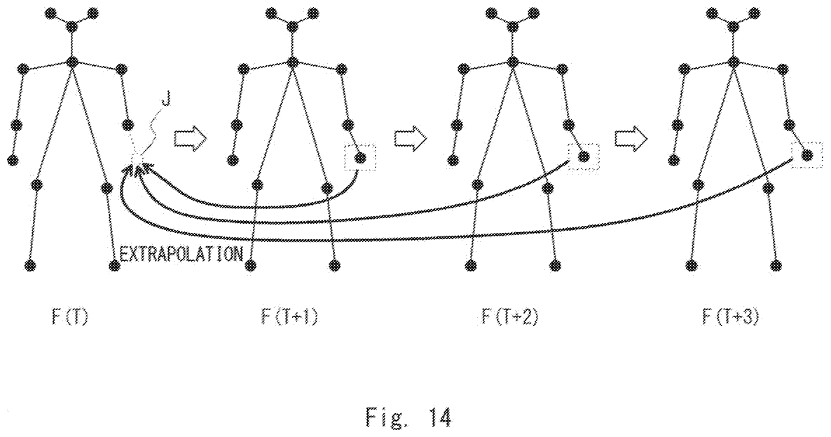

In addition, a frame used for the interpolation processing may be not only a past frame but also a frame temporally later than the frame of interest (i.e., a future frame). For example, when a plurality of temporally consecutive frames are already stored in a storage unit 15, a frame at a certain point in time may be used as the frame of interest, and the interpolation processing may be performed by using a frame being in future rather than the frame of interest. FIG. 14 illustrates an example in which the joint point J of the frame of interest F(T) is interpolated by using three frames F(T+1) to F(T+3) in future rather than the frame of interest F(T). Even in this case, in the three future frames F(T+1) to F(T+3), the joint point J of the frame of interest F(T) may be interpolated by detecting joint points associated to the joint point J and performing extrapolation on coordinates of the detected joint points. As described above, by performing the interpolation processing using three or more future frames, it is possible to interpolate the joint point J with high accuracy. For example, when a joint point of a frame in which detection of one or more joint points has failed is posteriorly interpolated from an already captured image, or the like, it is possible to perform the interpolation processing by using a future frame in this manner.

Note that, frames to be referred to are not limited to the frames F(T+1) to F(T+3), and may be a plurality of any future frames. In addition, as long as interpolation of a joint point can be appropriately performed, the plurality of future frames to be referred to may be continuous in time or may be intermittent.

In addition, coordinates interpolated by the interpolation processing using a past frame and coordinates interpolated by the interpolation processing using a future frame may be generated, and a middle point of the two coordinates acquired by interpolation may be set as the joint point J of the frame of interest.

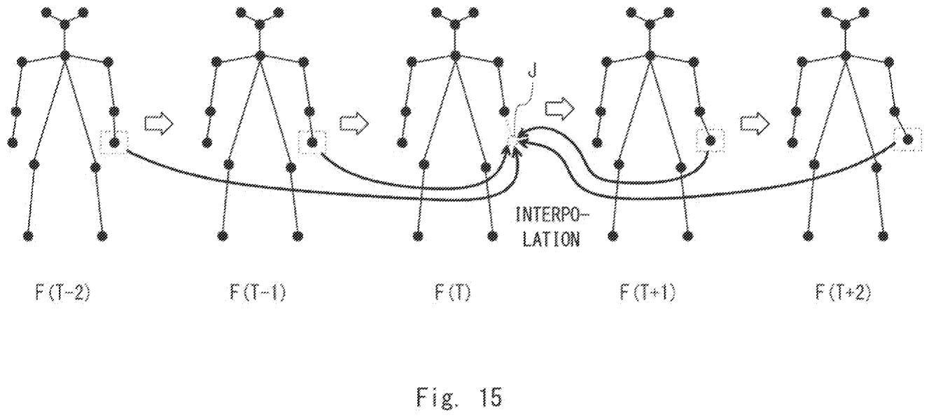

Further, a joint point of a frame of interest may be interpolated by using both past and future frames. FIG. 15 illustrates an example of interpolating a joint point of a frame of interest by using both past and future frames. Herein, for the sake of simplicity, the interpolation processing using the previous frame F(T−1), the previous frame F(T−2) being one previous to the previous frame, a next frame F(T+1), and a next frame F(T+2) being one next to the next frame will be described. Since the frame of interest F(T) is sandwiched between the past frame and the future frame, it is possible to suitably interpolate the joint point J of the frame of interest F(T) by performing interpolation on four frames sandwiching the frame of interest F(T) in Step S15. In this case, since the interpolation can be performed, the joint point J of the frame of interest F(T) can be interpolated with higher accuracy as compared with a case where the extrapolation is performed as described above.

Note that, frames to be referred to are not limited to the above, and may be a plurality of any future frames and a plurality of any past frames. In addition, as long as interpolation of a joint point can be appropriately performed, the frames to be referred to may be continuous in time or may be intermittent.

### Third Example Embodiment

An operation of a pose detection device 10 according to the first and second example embodiments described above is one example, and various modifications can be made as described below. Hereinafter, description will be made in detail.

### Modification Example of Step S13

A method of determining whether a joint point J detected in a frame of interest F(T) is a joint point to be detected in Step S13 is not limited to the above. Hereinafter, a specific example will be described.

In Step S13, an example in which a linear distance is used as a predetermined amount for determining whether positions of joint points are different from each other has been described, but a rotation angle with an adjacent joint point as an axis may be used as a predetermined amount. In this case, when a rotation angle of a joint point to be detected is larger than a predetermined rotation angle, it can be determined that the detected joint point is not a joint point to be detected.

In addition, a predicted position of the joint point J in the frame of interest F(T) may be calculated from a plurality of past or future frames, and when the joint point J is separated from the predicted position by a predetermined amount, it may be determined that the detected joint point J is not a joint point to be detected. In this case, velocity or angular velocity of a joint point associated to the joint point J in the frame of interest F(T) may be calculated from a plurality of past or future frames, and the predicted position of the joint point J may be calculated by using the calculated velocity or angular velocity.

Further, in Step S13, it may be determined whether positions of joint points are different from each other by using a standard deviation of pixel values of pixels around a detected joint point. In this case, the standard deviation of the pixel values of the pixels around the joint point detected in the frame of interest is calculated, and also pixels in the same area are extracted in the past or future frames and the standard deviation of pixel values of the extracted pixels. Then, when the standard deviation of the pixel value of the frame of interest changes more than a predetermined value with respect to the standard deviation of the pixel value of the past or future frame, it may be determined that the detected joint point is not a joint point to be detected. At this time, various pixel values such as an RGB value and a HSV value may be used as a pixel value to be used.

A determination method described above may be used alone or in combination in Step S13. In a case where a plurality of methods are combined, when it is determined that a joint point detected in determination of any method is not a joint point to be detected, it may be determined, as a determination result in Step S13, that the joint point is not a joint point to be detected. In addition, when it is determined that a joint point detected in determination of any method is a joint point to be detected, it may be determined, as a determination result in Step S13, that the joint point is a joint point to be detected. In addition, a determination result in Step S13 may be determined by majority voting of the determination result in all methods. Further, when it is determined in all methods that the joint point is not a joint point to be detected, it may be determined, as a determination result in Step S13, that the joint point is not a joint point to be detected.

Furthermore, it may be determined, by using machine learning, that a joint point detected is not a joint point to be detected. In this case, for example, a learned model in which a detection result of a joint point of a subject is learned by machine learning is generated in advance. Then, by inputting, to the learned model, a frame of interest and a past or current frame to be compared, it may be determined that a joint point detected in the frame of interest is not a joint point to be detected.

### Modification Example of Step S15

A method of interpolating a joint point in Step S15 is not limited to the above. Hereinafter, a specific example will be described.

For example, a predicted position of the joint point J in the frame of interest F(T) may be calculated from a plurality of past or future frames, and the joint point J may be added to the calculated predicted position. In this case, velocity and angular velocity of a joint point associated to the joint point J in the frame of interest F(T) may be calculated from a plurality of past or future frames, and the predicted position of the joint point J may be calculated by using the calculated velocity and angular velocity.

### Fourth Example Embodiment

In the above-described example embodiments, it is described that a pose detection system 100 is configured by a camera 110 and a pose detection device configured as a device different from the camera 110. In contrast, in the present example embodiment, an example in which a camera and a pose detection device are configured as one system will be described.

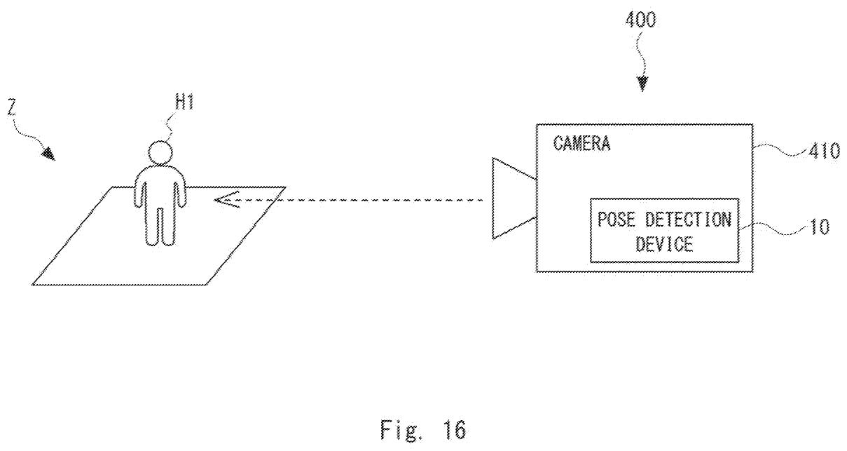

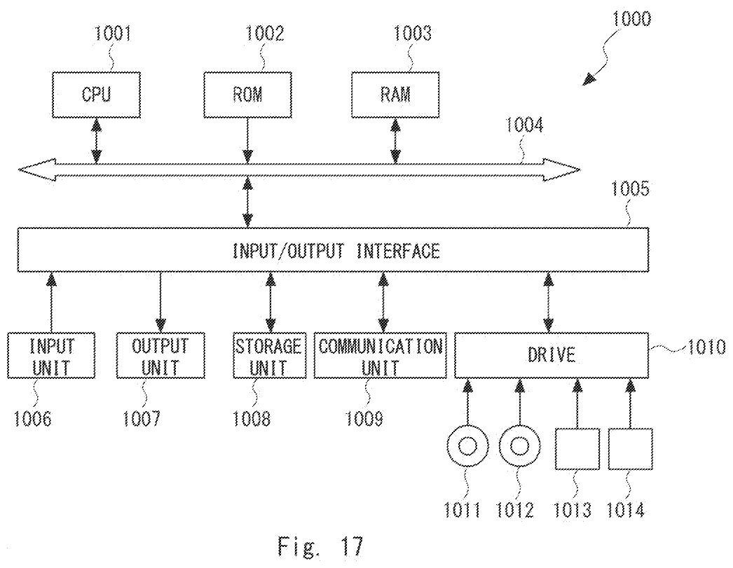

A pose detection system 400 according to the fourth example embodiment will be described. FIG. 16 schematically illustrates a configuration of the pose detection system 400 according to the fourth example embodiment. The pose detection system 400 has a configuration in which a pose detection device 10 is incorporated in a camera 410.

Recent image capturing device performs capturing by using a charge coupled device (CCD) image sensor or a complementary metal oxide semiconductor (CMOS) image sensor. Therefore, a processing device having a high computing capability is mounted on the image capturing device. Therefore, in the present example embodiment, the camera 410 itself incorporates the pose detection device 10 by achieving a function of the pose detection device 10 with a processing device mounted on the image capturing device, a processing unit that can be additionally mounted on the processing device, or the like.

Accordingly, it is possible to provide the pose detection system 400 including the camera 410 and the pose detection device 10 incorporated in the camera 410. This makes it possible to achieve a more compact pose detection system.

### Another Example Embodiment

Note that, the present disclosure is not limited to the above-described example embodiments, and can be appropriately modified without departing from the spirit. For example, a joint point of a subject described above is merely an example, and the number of joint points may be other than 14, and a position of each joint point may be changed as appropriate.

Although the present disclosure has been described as a hardware configuration in the above-described example embodiments, the present disclosure is not limited thereto. The present disclosure can also be achieved processing in a processing device by causing a central processing unit (CPU) to execute a computer program. In addition, the above-described program can be stored and provided to a computer using any type of non-transitory computer readable media. Non-transitory computer-readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

One example of a computer will be described. The computer can be achieved by various computers such as a dedicated computer and a personal computer (PC). However, the computer does not need to be physically single, and may be a plurality of computers when executing distributed processing.

FIG. 17 illustrates a configuration example of a computer. A computer 1000 in FIG. 17 includes a central processing unit (CPU) 1001, a read only memory (ROM) 1002, and a random access memory (RAM) 1003, which are connected to one another via a bus 1004. Note that, although description of OS software and the like for operating the computer is omitted, it is assumed that a computer for constructing a pose detection device 10 is naturally included.

An input/output interface 1005 is also connected to the bus 1004. The input/output interface 1005 is connected with, for example, an input unit 1006 including a keyboard, a mouse, a sensor, and the like, an output unit 1007 including a display including a CRT, an LCD, and the like, a headphone, a speaker, and the like, a storage unit 1008 configured by a hard disk and the like, a communication unit 1009 configured by a modem, a terminal adaptor, and the like, and the like.

The CPU 1001 executes various processing according to various programs stored in the ROM 1002 or various programs loaded from the storage unit 1008 into the RAM 1003, and in the above-described example embodiments, for example, processing of each unit of the pose detection device 10 described later. Note that, similarly to the CPU 1001, a graphics processing unit (GPU) may be provided, and execute various processing according to various programs stored in the ROM 1002 or various programs loaded from the storage unit 1008 into the RAM 1003, and in the present example embodiments, for example, processing of each unit of the pose detecting device 10. Note that, the GPU is suitable for a purpose of performing routine processing in parallel, and it is also possible to improve a processing speed as compared with the CPU 1001 by applying the GPU to processing in a neural network described later. The RAM 1003 also stores, as appropriate, data and the like necessary for the CPU 1001 and the GPU to execute various processing.

The communication unit 1009 performs, for example, communication processing via the not-illustrated Internet, transmits data provided from the CPU 1001, and outputs data received from a communication partner to the CPU 1001, the RAM 1003, and the storage unit 1008. The storage unit 1008 communicates with the CPU 1001, and stores and deletes information. The communication unit 1009 also performs communication processing of an analog signal or a digital signal with another device.

The input/output interface 1005 is also connected to a drive 1010 as necessary, for example, a magnetic disk 1011, an optical disk 1012, a flexible disk 1013, a semiconductor memory 1014, or the like are appropriately mounted, and a computer program read from them is installed in the storage unit 1008 as necessary.

In the above-described example embodiments, for example, a magnitude determination of two values has been described in Step S13, but this is merely an example, and a case where the two values are equal in the magnitude determination of the two values may be handled as necessary. In other words, any of determination as to whether a first value is equal to or greater than a second value or less than the second value, and determination as to whether the first value is greater than the second value or equal to or less than the second value may be adopted as necessary. Any of determination as to whether the first value is equal to or less than the second value or greater than the second value, and determination as to whether the first value is less than the second value or equal to or greater than the second value may be adopted. In other words, when the magnitude determination of the two values is performed and acquired two determination results, a case where the two values are equal may be included in any of the two determination results as necessary.

The first to fourth example embodiments can be combined as desirable by one of ordinary skill in the art.

While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

The whole or part of the exemplary embodiments disclosed above can be described as, but not limited to, the following supplementary notes.

### (Supplementary Note 1)

A pose detection device including: a memory configured to store instructions; and a processor configured to execute the instructions to: acquire a frame of interest to be subjected to pose detection from a plurality of time-series frames, and detect a joint point of a subject reflected in the frame of interest; determine that a joint point to be detected in the frame of interest cannot be detected when the detected joint point is not the joint point to be detected in the frame of interest; search for a joint point associated to the joint point to be detected in the frame of interest with respect to each of a plurality of frames other than the frame of interest among the plurality of time-series frames when the joint point to be detected in the frame of interest cannot be detected; and interpolate the joint point to be detected in the frame of interest according to a search result.

### (Supplementary Note 2)

The pose detection device according to Supplementary note 1, in which, when the detected joint point and the joint point to be detected in the frame of interest are separated from each other by a predetermined amount, it is determined that the joint point to be detected in the frame of interest cannot be detected.

### (Supplementary Note 3)

The pose detection device according to Supplementary note 2, in which, when a distance between the detected joint point and the joint point to be detected in the frame of interest is longer than a predetermined distance, it is determined that the joint point to be detected in the frame of interest cannot be detected.

### (Supplementary Note 4)

The pose detection device according to Supplementary note 2, in which, when a rotation amount of the detected joint point is larger than a predetermined rotation amount, it is determined that the joint point to be detected in the frame of interest cannot be detected.

### (Supplementary Note 5)

The pose detection device according to any one of Supplementary notes 1 to 3, wherein the memory stores the plurality of frames, and a frame in the plurality of frames stored in the memory can be read.

### (Supplementary Note 6)

The pose detection device according to Supplementary note 5, in which the frame of interest is stored in the memory, and the frame of interest from the memory can be read.

### (Supplementary Note 7)

The pose detection device according to any one of Supplementary notes 1 to 3, in which, when a joint point associated to the joint point to be detected in the frame of interest is found in each of the plurality of frames, the joint point to be detected in the frame of interest is interpolated by using coordinates of the found joint points.

### (Supplementary Note 8)

The pose detection device according to Supplementary note 7, in which, when the plurality of frames are a past frame or a future frame than the frame of interest, the joint point to be detected in the frame of interest is interpolated by performing extrapolation on the found joint points.

### (Supplementary Note 9)

The pose detection device according to Supplementary note 7, in which, when the plurality of frames are constituted of a past frame and a future frame sandwiching the frame of interest, the joint point to be detected in the frame of interest is interpolated by performing interpolation on the found joint points.

### (Supplementary Note 10)

The pose detection device according to Supplementary note 7, in which a position of the joint point to be detected in the frame of interest is predicted from the joint points found in the plurality of frames, and the joint point to be detected in the frame of interest is interpolated by a joint point at the predicted position.

### (Supplementary Note 11)

The pose detection device according to Supplementary note 7, in which, when a joint point associated to the joint point to be detected in the frame of interest cannot be found in the plurality of frames, the joint point to be detected in the frame of interest is interpolated by performing interpolation on a plurality of detected joint points around the joint point to be detected in the frame of interest.

### (Supplementary Note 12)

A pose detection system including: an image capturing device configured to output an image acquired by capturing an area to be monitored; and a pose detection device configured to detect a pose of a subject being a person reflected in the image, in which the pose detection device includes a memory configured to store instructions; and a processor configured to execute the instructions to: acquire a frame of interest to be subjected to pose detection from a plurality of time-series frames, and detect a joint point of a subject reflected in the frame of interest, determine that a joint point to be detected in the frame of interest cannot be detected when the detected joint point is not the joint point to be detected in the frame of interest; search for a joint point associated to the joint point to be detected in the frame of interest with respect to each of a plurality of frames other than the frame of interest among the plurality of time-series frames when the joint point to be detected in the frame of interest cannot be detected; and interpolate the joint point to be detected in the frame of interest according to a search result.

### (Supplementary Note 13)

A pose detection system including: an image capturing device configured to output an image acquired by capturing an area to be monitored; and a pose detection device configured to be incorporated in the image capturing device and detect a pose of a subject being a person reflected in the image, in which the pose detection device includes a memory configured to store instructions; and a processor configured to execute the instructions to: acquire a frame of interest to be subjected to pose detection from a plurality of time-series frames, and detect a joint point of a subject reflected in the frame of interest, determine that a joint point to be detected in the frame of interest cannot be detected when the detected joint point is not the joint point to be detected in the frame of interest, search for a joint point associated to the joint point to be detected in the frame of interest with respect to each of a plurality of frames other than the frame of interest among the plurality of time-series frames when the joint point to be detected in the frame of interest cannot be detected, and interpolate the joint point to be detected in the frame of interest according to a search result.

### (Supplementary Note 14)

A pose detection method including: acquiring a frame of interest to be subjected to pose detection from a plurality of time-series frames, and detecting a joint point of a subject reflected in the frame of interest; determining that a joint point to be detected in the frame of interest cannot be detected when a detected joint point is not the joint point to be detected in the frame of interest; searching for a joint point associated to the joint point to be detected in the frame of interest with respect to each of a plurality of frames other than the frame of interest among the plurality of time-series frames when the joint point to be detected in the frame of interest cannot be detected; and interpolating the joint point to be detected in the frame of interest according to a search result of a joint point.

### (Supplementary Note 15)

A program causing a computer to execute a process including: acquiring a frame of interest to be subjected to pose detection from a plurality of time-series frames, and detecting a joint point of a subject reflected in the frame of interest; determining that a joint point to be detected in the frame of interest cannot be detected when a detected joint point is not the joint point to be detected in the frame of interest; searching for a joint point associated to the joint point to be detected in the frame of interest with respect to each of a plurality of frames other than the frame of interest among the plurality of time-series frames when the joint point to be detected in the frame of interest cannot be detected; and interpolating the joint point to be detected in the frame of interest according to a search result of a joint point.

What is claimed is:

1. A pose detection device comprising:
a memory configured to store instructions; and
a processor configured to execute the instructions to:
acquire a frame of interest to be subjected to pose detection from a plurality of time-series frames, and detect a joint point of a subject reflected in the frame of interest;
determine that a joint point to be detected in the frame of interest cannot be detected when the detected joint point is not the joint point to be detected in the frame of interest;
search for a joint point associated to the joint point to be detected in the frame of interest with respect to each of a plurality of frames other than the frame of interest among the plurality of time-series frames when the joint point to be detected in the frame of interest cannot be detected; and
interpolate the joint point to be detected in the frame of interest according to a search result.

2. The pose detection device according to claim 1, wherein, when the detected joint point and the joint point to be detected in the frame of interest are separated from each other by a predetermined amount, it is determined that the joint point to be detected in the frame of interest cannot be detected.

3. The pose detection device according to claim 2, wherein, when a distance between the detected joint point and the joint point to be detected in the frame of interest is longer than a predetermined distance, it is determined that the joint point to be detected in the frame of interest cannot be detected.

4. The pose detection device according to claim 2, wherein, when a rotation amount of the detected joint point is larger than a predetermined rotation amount, it is determined that the joint point to be detected in the frame of interest cannot be detected.

5. The pose detection device according to claim 1, wherein the memory stores the plurality of frames, and
a frame in the plurality of frames stored in the memory can be read.

6. The pose detection device according to claim 5, wherein
the frame of interest is stored in the memory, and
the frame of interest from the memory can be read.

7. The pose detection device according to claim 1, wherein, when a joint point associated to the joint point to be detected in the frame of interest is found in each of the plurality of frames, the joint point to be detected in the frame of interest is interpolated by using coordinates of the found joint points.

8. The pose detection device according to claim 7, wherein, when the plurality of frames are a past frame or a future frame than the frame of interest, the joint point to be detected in the frame of interest is interpolated by performing extrapolation on the found joint points.

9. The pose detection device according to claim 7, wherein, when the plurality of frames are constituted of a past frame and a future frame sandwiching the frame of interest, the joint point to be detected in the frame of interest is interpolated by performing interpolation on the found joint points.

10. The pose detection device according to claim 7, wherein a position of the joint point to be detected in the frame of interest is predicted from the joint points found in the plurality of frames, and the joint point to be detected in the frame of interest is interpolated by a joint point at the predicted position.

11. The pose detection device according to claim 7, wherein, when a joint point associated to the joint point to be detected in the frame of interest cannot be found in the plurality of frames, the joint point to be detected in the frame of interest is interpolated by performing interpolation on a plurality of detected joint points around the joint point to be detected in the frame of interest.

12. A pose detection system comprising:
an image capturing device configured to output an image acquired by capturing an area to be monitored; and
a pose detection device configured to detect a pose of a subject being a person reflected in the image,
wherein the pose detection device includes
a memory configured to store instructions; and
a processor configured to execute the instructions to:
acquire a frame of interest to be subjected to pose detection from a plurality of time-series frames, and detect a joint point of a subject reflected in the frame of interest,
determine that a joint point to be detected in the frame of interest cannot be detected when the detected joint point is not the joint point to be detected in the frame of interest;
search for a joint point associated to the joint point to be detected in the frame of interest with respect to each of a plurality of frames other than the frame of interest among the plurality of time-series frames when the joint point to be detected in the frame of interest cannot be detected; and
interpolate the joint point to be detected in the frame of interest according to a search result.

13. A pose detection method comprising:
acquiring a frame of interest to be subjected to pose detection from a plurality of time-series frames, and detecting a joint point of a subject reflected in the frame of interest;
determining that a joint point to be detected in the frame of interest cannot be detected when a detected joint point is not the joint point to be detected in the frame of interest;
searching for a joint point associated to the joint point to be detected in the frame of interest with respect to each of a plurality of frames other than the frame of interest among the plurality of time-series frames when the joint point to be detected in the frame of interest cannot be detected; and
interpolating the joint point to be detected in the frame of interest according to a search result of a joint point.
